(19) United States
(12) Patent Application Publication
(10) Pub. No.: US 2026/0091647 A1
(43) Pub. Date: Apr. 2, 2026

(54) VEHICLE THERMAL MANAGEMENT SYSTEM

(71) Applicants: HYUNDAI MOTOR COMPANY, Seoul (KR); KIA CORPORATION, Seoul (KR)

(72) Inventors: Se Kyu Oh, Hwaseong-si (KR); Jae Kwon Lee, Hwaseong-si (KR); Ki Hoon Kim, Hwaseong-si (KR); Jae Woong Kim, Hwaseong-si (KR); Dae Ki Hong, Hwaseong-si (KR)

(73) Assignees: HYUNDAI MOTOR COMPANY, Seoul (KR); KIA CORPORATION, Seoul (KR)

(21) Appl. No.: 19/199,022

(22) Filed: May 5, 2025

(30) Foreign Application Priority Data
Sep. 27, 2024 (KR) 10-2024-0131998

(51) Int. Cl. B60H 1/00; B60H 1/14

(52) U.S. Cl. CPC B60H 1/00885; B60H 1/0073; B60H 1/14

(57) ABSTRACT

A vehicle thermal management system controls a fluid transport device based on an optimal control value derived using a preset control model for a predicted state value according to a current state value. The optimal control value is a control value that satisfies constraint conditions on at least one of a target temperature of indoor cooling or a target temperature range of component thermal management while consuming the minimum power.

### CROSS REFERENCE TO RELATED APPLICATION

The present application claims priority to Korean Patent Application No. 10-2024-0131998 filed on Sep. 27, 2024, the entire contents of which are incorporated herein for all purposes by this reference.

### BACKGROUND OF THE DISCLOSURE

### Technical Field

The present disclosure relates to a vehicle thermal management system for performing thermal management of a vehicle based on an optimal control value through a predictive model.

### Description of the Related Art

Recently, as interest in the environment has increased, the number of eco-friendly vehicles equipped with electric motors as a power source is increasing. Eco-friendly vehicles are referred to as electrified vehicles, and representative examples of the eco-friendly vehicles may include hybrid electric vehicles (HEV) or electric vehicles (EV). Since these electric vehicles consume electric energy for driving and for indoor air conditioning as well, the efficiency of indoor air conditioning significantly affects the energy efficiency of the vehicle and overall energy efficiency including the same.

In particular, among the electric vehicles, electric vehicles that travel through only a driving force of a motor without an engine require even greater energy efficiency because the waste heat of the engine cannot be recovered and used for indoor air conditioning.

In addition, the electric vehicles have components such as a high-voltage battery and a motor for driving. Since the operating performance of these components is affected by a temperature, it is increasingly necessary to consider the indoor air conditioning and the requirements for the components in terms of thermal management as well.

The matters explained as the background art are for the purpose of enhancing the understanding of the background of the present disclosure and should not be taken as acknowledging that they correspond to the related art already known to those having ordinary skill in the art.

### SUMMARY OF THE DISCLOSURE

To optimally perform the thermal management of the vehicle to improve the energy efficiency of the entire vehicle, it is necessary to comprehensively consider constraints on each vehicle component, the indoor air conditioning goals, and the like.

The present disclosure is directed to providing a vehicle thermal management system capable of comprehensively performing thermal management of the entire vehicle by individually or comprehensively considering indoor air conditioning goals and constraint conditions on the thermal management of vehicle components.

Objects of the present disclosure are not limited to the above-described object. Other objects that are not mentioned herein should be more clearly understood by those having ordinary skill in the art from the following description.

A vehicle thermal management system according to one embodiment of the present disclosure includes a fluid transport device configured to selectively perform indoor cooling through air discharge into a vehicle interior and component thermal management through heat exchange with at least one vehicle component. The fluid transport device includes a power consumption unit configured to consume power to perform the indoor cooling and the component thermal management. The vehicle thermal management system further includes a control unit configured to control the fluid transport device based on an optimal control value derived using a preset control model for a predicted state value according to a current state value.

The optimal control value may be a control value that satisfies constraint conditions on at least one of a target temperature of the indoor cooling or a target temperature range of the component thermal management while consuming the minimum power through the power consumption unit.

According to various embodiments of the present disclosure, it is possible to satisfy the thermal management goals for thermal management targets while consuming the minimum power by comprehensively considering the interaction between the thermal management targets.

In particular, the thermal management system according to various embodiments of the present disclosure can be applied to both a case in which control of tracking a target value is required and a case in which control for management within a target range is required in satisfying the thermal management goals. Further, the thermal management system according to various embodiments of the present disclosure can simultaneously perform tracking control and management control as needed.

The effects obtainable from the present disclosure are not limited to the above-described effects, and other effects that are not mentioned herein should be clearly understood by those having ordinary skill in the art to which the present disclosure pertains from the following description.

### BRIEF DESCRIPTION OF THE DRAWINGS

The above and other objects, features and other advantages of the present disclosure are more clearly understood from the following detailed description when taken in conjunction with the accompanying drawings, in which:

FIG. 1 is a view showing an example of a configuration of a fluid transport device of a thermal management system that may be applied to embodiments of the present disclosure;

FIG. 2 is a view showing a configuration of the vehicle thermal management system according to one embodiment of the present disclosure;

FIG. 3 is a view for describing an optimal control process of a control unit according to one embodiment of the present disclosure; and

FIGS. 4-6 are views for describing a thermal management control process of a vehicle according to one embodiment of the present disclosure.

### DETAILED DESCRIPTION

Specific structural and functional descriptions of embodiments of the present disclosure disclosed in the specification or the application are merely illustrative for the purpose of describing embodiments of the present disclosure. Embodiments of the present disclosure may be implemented in various forms and should not be construed as being limited to the embodiments described in the specification or the application.

Since embodiments of the present disclosure may be variously changed and may have various forms, specific embodiments are illustrated in the drawings and described in detail in the specification or the application. However, it should be understood that this is not intended to limit the present disclosure to a specific form specifying embodiments according to the concept of the present disclosure. Embodiments disclosed in the present disclosure include all changes, equivalents, and substitutions included within the spirit and technical scope of the present disclosure.

Unless defined otherwise, all terms used herein, including technical or scientific terms, have the same meaning as commonly understood by those having ordinary skill in the art to which the present disclosure pertains. The terms defined in a generally used dictionary should be construed as having meanings that coincide with the meanings of the terms from the context of the related technology and should not be construed as an ideal or excessively formal meaning unless clearly defined in this document.

Hereinafter, embodiments disclosed in this specification are described in detail with reference to the accompanying drawings. The same or similar components are denoted by the same reference numerals regardless of the drawing symbols, and overlapping descriptions thereof have been omitted.

In the following description of embodiments, the term “preset” means that a value of a parameter is predetermined when using the parameter in a process or an algorithm. According to embodiments, the value of the parameter may be set when the process or the algorithm starts or set during a section in which the process or the algorithm is performed.

The suffixes “module” and “unit” for components used in the following description are given or used interchangeably in consideration of ease of preparing the specification and do not have meanings or roles that are distinct from each other by themselves.

In describing embodiments disclosed in the specification, where it has been determined that a detailed description of a related known technology may obscure the gist of embodiments disclosed in this specification, a detailed description thereof has been omitted. In addition, the accompanying drawings are only for easy understanding of the embodiments disclosed in the specification. It should be understood that the technical spirit disclosed in the specification is not limited by the accompanying drawings. All changes, equivalents, or substitutes included in the spirit and technical scope of the present disclosure are included in the present disclosure.

Terms including ordinal numbers such as “first,” “second” or the like may be used to describe various components, but the components are not limited by the terms. The terms are used only for the purpose of distinguishing one component from another.

When a first component is described as being “connected” or “coupled” to a second component, it should be understood that the first component may be directly connected or coupled to the second component, or a third component may be present therebetween. On the other hand, when a certain component is described as “directly connected” or “directly coupled” to another component, it should be understood that other components are not present therebetween.

The singular includes the plural unless the context clearly dictates otherwise.

In the specification, it should be understood that the term “comprise,” “include,” or “have” is intended to specify that a feature, a number, a step, an operation, a component, a part, or a combination thereof described in the specification is present, but do not preclude the possibility of the presence or addition of one or more other features, numbers, steps, operations, components, parts, or combinations thereof. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

In addition, a unit or control unit included in the name of a motor control unit (MCU), a hybrid control unit (HCU), or the like is the term widely used for naming a controller for controlling a specific function of a vehicle and does not mean a generic function unit.

A controller may include a communication device for communicating with another controller or a sensor to control a function in charge. The controller may also include a memory for storing an operating system or logic commands and input and output information. Further, the controller may include one or more processors for performing determination, calculation, decision, and the like necessary for controlling the function in charge. When a component, unit, controller, device, element, apparatus, or the like (i.e., an apparatus) of the present disclosure is described as having a purpose or performing an operation, function, or the like, the component, unit, controller, device, element, apparatus, or the like should be considered herein as being “configured to” meet that purpose or to perform that operation or function. Each component, unit, controller, device, element, apparatus, and the like may separately embody or be included with a processor and a memory, such as a non-transitory computer readable media, as part of the apparatus.

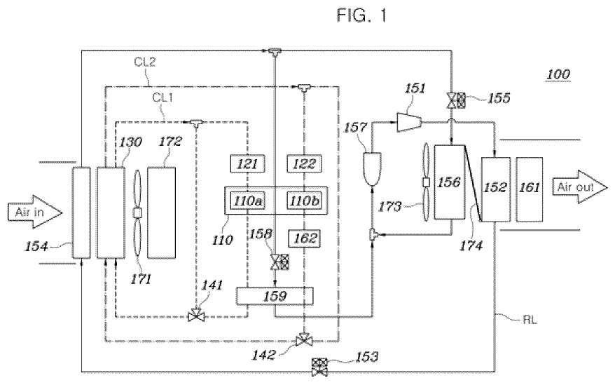

Hereinafter, before describing the operation of a control unit for performing the thermal management of a vehicle according to one embodiment of the present disclosure, an implementation example of a fluid transport device applicable to embodiments of the present disclosure is first be described with reference to FIG. 1.

FIG. 1 is a view showing an example of a configuration of a fluid transport device of a thermal management system that may be applied to embodiments of the present disclosure.

Referring to FIG. 1, a fluid transport device 100 applicable to embodiments of the present disclosure may perform vehicle thermal management, such as cooling or heating at least one vehicle component 110, cooling or heating a vehicle indoors (cabin), and the like.

To this end, the fluid transport device 100 may be provided with coolant lines CL1 and CL2 that exchange heat with the vehicle component 110 and provided with a refrigerant line RL that exchanges heat with coolant and surrounding air.

More specifically, the fluid transport device 100 may be provided with the plurality of coolant lines CL1 and CL2, and the coolant lines CL1 and CL2 may individually heat exchange with the vehicle components 110 for the thermal management of different vehicle components 110.

The vehicle component 110 may include a drive system 110a such as a motor and an inverter, and a battery 110b. However, in embodiments of the present disclosure, the vehicle component 110 is not necessarily limited to the above examples and may include any component that requires heat dissipation. For example, the vehicle component 110 may include any type of a controller (not shown), such as an autonomous driving controller, a motor controller, a vehicle controller, and a controller involved in performing integrated thermal management according to one embodiment of the present disclosure.

Although FIG. 1 shows the coolant line CL1 for the thermal management of the drive system 110a and the coolant line CL2 for the thermal management of the battery 110b, in the implementation of the fluid transport device 100, the coolant lines CL1 and CL2 may be replaced with coolant lines for the thermal management of another vehicle component 110 such as a controller or may coexist with coolant lines for the thermal management of another vehicle component 110. In addition, examples of the implementation of the fluid transport device 100 may include various cases, such as a case in which only a single coolant line is provided for the thermal management of the single vehicle component 110, a case in which a plurality of vehicle components 110 are connected in series to one coolant line, and the like.

Pumps 121 and 122 for circulating coolant may be provided in the coolant lines CL1 and CL2. The pumps 121 and 122 may consume power to flow the coolant toward the vehicle component 110. The pumps 121 and 122 may be implemented as, for example, an electric water pump (EWP) for circulating coolant by driving a motor through electric energy.

Coolant flowing into the vehicle component 110 through the pumps 121 and 122 may absorb heat generated from the vehicle component 110 through heat exchange while passing through the vehicle component 110, thereby cooling the vehicle component 110.

The coolant passing through the vehicle component 110 may flow toward a radiator 130 and in the process of passing through the radiator 130, releases the heat absorbed from the vehicle component 110 to the periphery, and is introduced back into the vehicle component 110.

In this case, the radiator 130 may be individually provided in each of the coolant lines CL1 and CL2. Further, the radiator 130 corresponding to each of the coolant lines CL1 and CL2 may be classified into, for example, a high-temperature radiator and a low-temperature radiator.

A compressor 151, a plurality of condensers 152 and 154, a plurality of expanders 153, 155, and 158, an evaporator 156, an accumulator 157, and a heat absorber 159 may be provided in the refrigerant line RL, and the fluid transport device 100 may perform a heat pump function through these components and discharge cooled air into the inside through the evaporator 156 to perform indoor cooling or discharge heated air into the inside through the condenser 152 to perform indoor heating.

The compressor 151 may consume power to implement the heat pump function through the circulation of the refrigerant to discharge the refrigerant at a high temperature and high pressure. The refrigerant passing through the compressor 151 repeats heat discharge and heat absorption to the periphery while passing through the indoor side condenser 152, the expander 153, the outdoor side condenser 154, the expander 155, the evaporator 156, and the accumulator 157.

In particular, the refrigerant line RL may pass through the coolant lines CL1 and CL2 to recover waste heat of the vehicle components 110 from the coolant lines CL1 and CL2 and exchange heat with the coolant lines CL1 and CL2 through the heat absorber 159 connected to the coolant lines CL1 and CL2. The fluid transport device 100 may have a plurality of heat absorbers 159 unlike that shown in FIG. 1, and the plurality of heat absorbers 159 may be connected to different coolant lines CL1 and CL2.

To perform vehicle heat management for different purposes, the fluid transport device 100 may form various heat transfer paths through the coolant lines CL1 and CL2.

For example, the coolant line CL1 for the thermal management of the drive system 110a may form a heat transfer path that discharges heat absorbed from the drive system 110a to the outside through the radiator 130 and a heat transfer path that transfers the heat absorbed from the drive system 110a to the refrigerant line RL through the heat absorber 159 and may simultaneously form these heat transfer paths.

The above heat transfer paths may be changed according to the flow direction of the coolant. Further, the flow direction of the coolant may be controlled by a valve 141 provided in the coolant line CL1, and the like. In addition, it is possible to suppress the circulation of the coolant by stopping the operation of the pump 121 or the like to prevent the heat generated from the drive system 110a from being discharged through the radiator 130 or the heat absorber 159.

As another example, the coolant line CL2 for the thermal management of the battery 110b may form a heat transfer path that discharges the heat absorbed from the battery 110b to the outside through the radiator 130 and a heat transfer path that does not pass through the radiator 130. In particular, in the heat transfer path that does not pass through the radiator 130, according to the refrigerant circulation of the refrigerant line RL, the heat generated from the battery 110b may be transferred to the refrigerant line RL through the heat absorber 159 to cool the battery 110b. Instead of transferring heat to the refrigerant line RL, the heat of the coolant heated through the heater 162 heating the coolant may be transferred to the battery 110b to heat the battery 110b. The above heat transfer paths may be changed according to the flow direction of the coolant. Further, the flow direction of the coolant may be controlled by a valve 142 provided in the coolant line CL2, and the like.

The fluid transport device 100 may also exchange heat with the outside air and use the heat absorbed through the heat exchange with the outside air for heat management. More specifically, the heat exchange with the outside air may be performed indirectly through the radiator 130, or may be performed through an external evaporator (not shown) that absorbs heat from the outside air.

In performing such thermal management, the fluid transport device 100 may control the air flow from the outside to the inside and may have a blowing device, an opening/closing device, and the like to control the air flow.

The blowing device may include, for example, a cooling fan 171 for controlling the introduction of outside air and a blower 173 for controlling the discharge of air into a vehicle interior, and the opening/closing device may include, for example, an air flap 172 for controlling the introduction of outside air and a temp door 174 for controlling the discharge of air into the interior. The blowing device and the opening/closing device may consume power to perform operations.

In addition, the fluid transport device 100 may include a heating device for heating the air or coolant. The heating device may include a heater 161 for heating air discharged into the vehicle interior. In this case, the heater 161 may be implemented as, for example, a positive temperature coefficient (PTC) heater.

In addition, the heating device may include a heater 162 for heating coolant to heat the battery 110b as described above.

According to the above-described structure of the fluid transport device 100, the thermal management of the vehicle may be performed in various ways. In particular, any thermal management scenario may be derived depending on an interior state of the vehicle, an exterior state of the vehicle, states of the vehicle components 110a and 110b, and the like.

FIG. 1 mainly shows components related to the description of the fluid transport device 100 applicable to embodiments of the present disclosure. The actual fluid transport device 100 may be implemented by including a larger or smaller number of components.

In addition, since the fluid transport device 100 described above with reference to FIG. 1 shows one implementation example applicable to embodiments of the present disclosure, the fluid transport device 100 according to embodiments of the present disclosure is not necessarily limited to the above description.

Hereinafter, the configuration of the vehicle thermal management system according to one embodiment is described based on the configuration of the fluid transport device 100 described in FIG. 1.

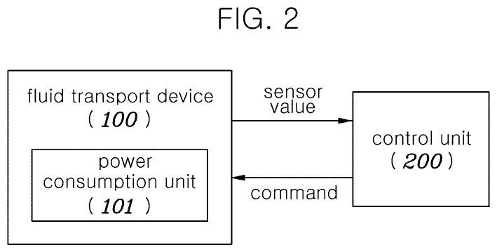

FIG. 2 is a view showing a configuration of the vehicle thermal management system according to one embodiment of the present disclosure.

Referring to FIG. 2, the vehicle thermal management system according to one embodiment includes the fluid transport device 100 and a control unit 200 for controlling the fluid transport device 100. However, FIG. 2 is a view mainly showing components related to the description of one embodiment. The actual vehicle thermal management system may be implemented by including a larger or smaller number of components. Hereinafter each component is described.

The fluid transport device 100 selectively performs indoor cooling through air discharge into the vehicle interior and component thermal management through heat exchange with at least one vehicle component and includes a power consumption unit 101 for consuming power to perform the indoor cooling and component thermal management. Therefore, the fluid transport device 100 may perform only the indoor cooling or component thermal management or perform the indoor cooling and component thermal management together. For example, the fluid transport device 100 may be implemented as in the example of FIG. 1.

The control unit 200 controls the fluid transport device 100 based on an optimal control value derived using a preset control model for a predicted state value according to a current state value. In this case, the optimal control value is a control value that satisfies constraint conditions on at least one of target temperature ranges of the indoor cooling and component thermal management while consuming the minimum power through the power consumption unit 101.

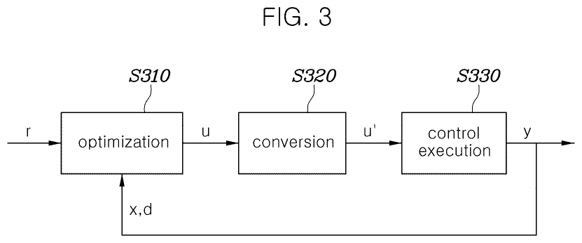

The derivation of the optimal control value through a control model for the predicted state value of the control unit 200 is described below with reference to FIG. 3.

FIG. 3 is a view for describing an optimal control process of a control unit according to one embodiment of the present disclosure.

Referring to FIG. 3, the control unit 200 according to one embodiment of the present disclosure may perform vehicle thermal management through processes of optimization S310, conversion S320, and control execution S330.

First, optimization S310 may be performed based on a model. For example, proportional, integral, differential (PID) control, linear quadratic regulator (LQR) control, or the like may be used for optimization, and in particular, optimization S310 according to one embodiment of the present disclosure may be performed through model-based predictive control (MPC).

More specifically, optimization S310 through the model-based predictive control may be performed to reduce future errors when basically deriving an optimal control value u that allows an output value y to follow a target value r.

To this end, the optimal control value u may be derived using a control model for the predicted state value according to a current state value x. In other words, the optimal control value u may be derived in consideration of both a current state and a predicted future state.

At least one of the current control value u and disturbance d in addition to the current state value x may be reflected in the control model for the predicted state value and may be expressed as, for example, the following expression.

$${X}_{k + 1} = {A}_{k} {x}_{k} + {B}_{k} {u}_{k} + {B}_{w , k} {w}_{k} + {B}_{φ , k}$$

In the above expression, xₖ and xₖ₊₁, respectively, denote a current state value and a predicted state value, and wₖ denotes disturbance. Aₖ, Bₖ, and B_{w,k} denote the influence of a current state, a control input, and disturbance on a future state, respectively. B_{φ,k} is a term to reflect the uncertainty of prediction.

By using the control model for the predicted state value, the predicted future state may be reflected in the derivation of the optimal control value.

In optimization S310, the optimization for the target value r may also be performed before deriving the optimal control value u. In this case, the optimization for the target value r may be performed in a steady state, and an output model for an output value may be used here. The output model for the output value represents the current state value and the output value according to the current control value and may be expressed, for example, as in the following expression.

$$[ \begin{matrix}{A}_{k} - I & {x}_{ss} \\ {C}_{k} & 0\end{matrix} ] [ \begin{matrix}{x}_{ss} \\ {u}_{ss}\end{matrix} ] - [ \begin{matrix}- ( {B}_{w , k} {w}_{k} + {B}_{φ , k} ) \\ r\end{matrix} ]$$

In the expression, xₛₛ and uₛₛ, respectively, denote a state value and control value in a steady state, and wₖ denotes disturbance. Aₖ, Bₖ, and B_{W},k denote the influence of a current state, a control input, and disturbance on a future state, respectively. Cₖ denotes the influence of a state value on an output value. Further, r denotes a target value, i.e., an output value that is the target of the control. B_{φ,k} is a term to reflect the uncertainty of prediction.

In contrast, in one embodiment, the process of optimizing the target value r in the steady state may be omitted. In this case, optimization may be performed so that the output value follows the target value in a dynamic state in which the state value fluctuates.

In optimization S310 through the model prediction-based control, the optimal control value u may be derived through a cost function for a preset prediction range.

The preset prediction range refers to how far into the future to be predicted and may be expressed as a prediction horizon. The greater the prediction range, the better optimization performance. However, a computational load of the control unit 200 for prediction may increase as much as the prediction range increases. In one embodiment, the optimal control value may be determined to be a control value that minimizes the cost function for the above prediction range, and a weight may be reflected in each item of the cost function.

The control value may be optimized in a dynamic state in which the state value x changes. In other words, the optimal control value u may be derived in the dynamic state. In this case, both the target value r and the optimal control value u may be optimized in the dynamic state (i.e., stage 1), the target value r may be optimized in the steady state, and the optimal control value u may be optimized in the dynamic state (i.e., stage 2).

The optimal control value u derived as above may be a physical quantity that affects vehicle thermal management according to the operation of each component of the fluid transport device 100, such as a mass flow rate of refrigerant or coolant or a mass flow rate of the air. In this case, the control unit 200 may convert the optimal control value u derived as the physical quantity through conversion S320 into an operating quantity u′ such as a rotational speed and duty for controlling the operations of the components of the fluid transport device 100. However, the optimal control value u is not necessarily limited to the above form and may have any form depending on each component of the fluid transport device 100. In this case, when the conversion into the operating quantity is unnecessary, conversion S320 may be omitted.

After optimization S310 and conversion S320 are performed, the actual control of the components of the fluid transport device 100 may be performed according to the optimal control value u and the operating quantity u′ accordingly. The result of performing the control may be shown in the form of the output value y. In this case, the output value y may be collected through various sensors provided in the vehicle and converted into a physical quantity as needed and then transmitted back to the control unit 200. In this case, the control unit 200 may determine the current state x and disturbance d according to the output value y and re-reflect the current state x and disturbance d in optimization S310.

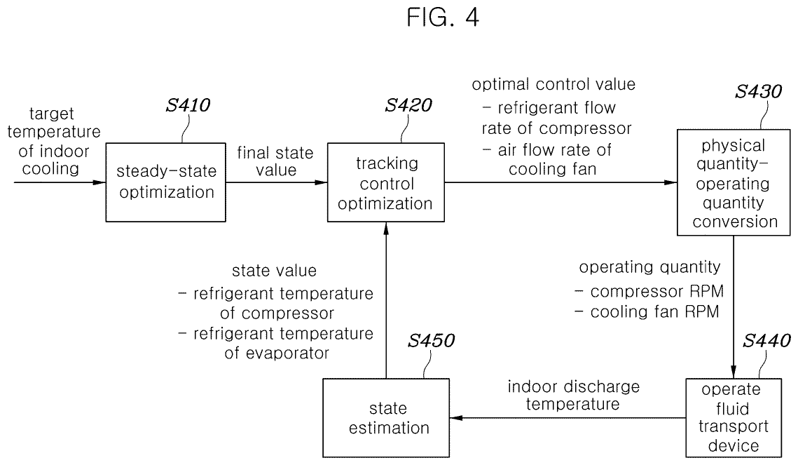

Hereinafter, a specific control operation performed by the control unit 200 in one embodiment of the present disclosure is described with reference to FIGS. 4-6.

FIGS. 4-6 are views for describing a thermal management control process of a vehicle according to one embodiment of the present disclosure.

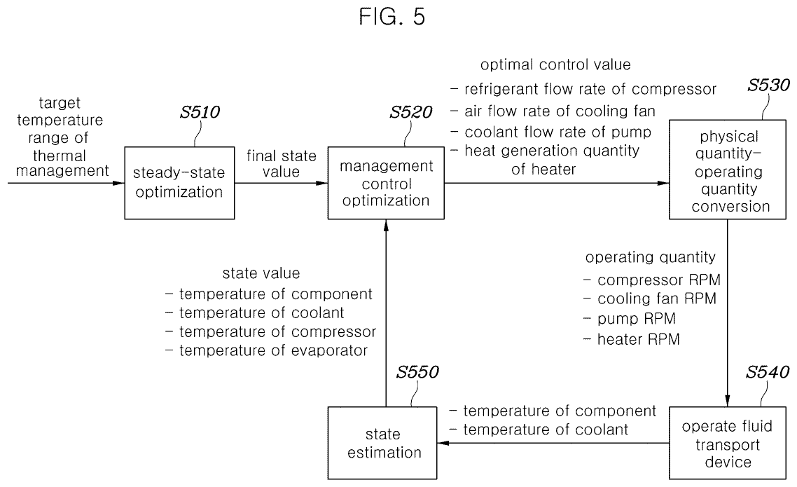

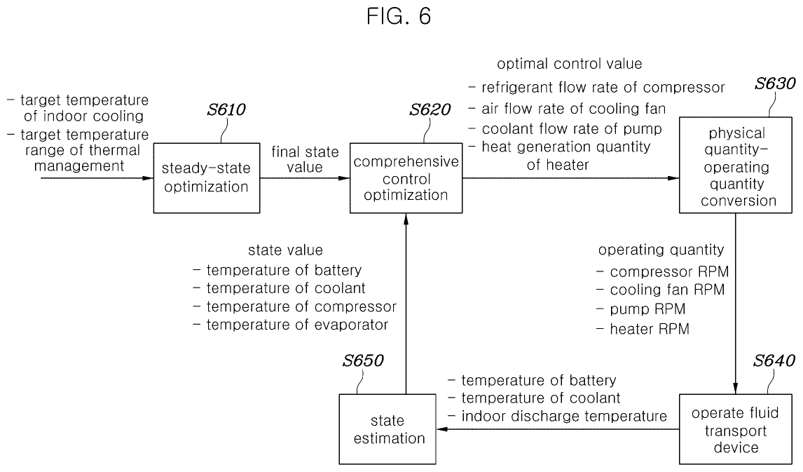

More specifically, FIG. 4 shows a case in which the control unit 200 performs control in consideration of constraint conditions on a target temperature of indoor cooling. FIG. 5 shows a case in which the control unit 200 performs control in consideration of a target temperature range of component thermal management. FIG. 6 shows a case in which control is performed in consideration of both the constraint conditions and the target temperature range.

The control unit 200 may perform control as shown in FIG. 4 when indoor cooling is performed through the fluid transport device 100. The control unit 200 may perform control as shown in FIG. 5 when component thermal management is performed through the fluid transport device 100. When both the indoor cooling and the component thermal management are performed through the fluid transport device 100, the control as shown in FIG. 6 may be performed. In addition, depending on a change in whether the indoor cooling is performed and a change in whether the component thermal management is performed, switching between the control processes as shown in FIGS. 4-6 may occur. For example, the control unit 200 may perform control as shown in FIG. 6 while both the indoor cooling and the component thermal management are performed. The control unit 200 may perform control as shown in FIG. 5 when the indoor cooling is ended. Hereinafter, each control process is described in detail.

First, referring to FIG. 4, the control unit 200 may perform steady-state optimization S410 before controlling the fluid transport device 100 based on the optimal control value. In this case, steady-state optimization S410 may be performed based on a target temperature of the indoor cooling. In this case, disturbance such as a vehicle speed, an outside temperature, a coolant flow rate, and an air flow rate may be considered together.

Steady-state optimization S410 may be performed based on a preset first output model for the result of indoor cooling and the power consumption of the power consumption unit 101. In this case, the control unit 200 may perform steady-state optimization S410 using the following expression.

$${g}_{t} ( {x}_{s} ) = {y}_{t , target}$$

In the expression, gₜ(xₛ) corresponding to the first output model denotes an indoor discharge temperature discharged from the fluid transport device 100 to the inside as the result of indoor cooling according to a final state value xₛ. Further, y_{t,target} denotes a target temperature of the indoor cooling.

In addition, the power consumption of the power consumption unit 101 may be considered in the form of a power model for the power consumption according to the state value and the control value as follows.

$$min {l}_{e} ( {x}_{s} , {u}_{x} ) = min {P}_{cons}$$

In the expression above, lₑ(xₛ,uₛ) denotes, as a power model, power consumption P_{cons} according to the final state value xₛ and a final control value uₛ according to a final time point of a prediction range. Therefore, the control unit 200 may derive the final state value xₛ and the final control value uₛ that minimize the power consumption P_{cons} output through the power model.

More specifically, the power consumption unit 101 may include the compressor 151 and the cooling fan 171 that are involved in the indoor cooling. In this case, the power consumption of the compressor 151 and the cooling fan 171 may be included in the power model, and the final state value may include a refrigerant temperature of the condenser 152 and a refrigerant temperature of the evaporator 156. In addition, the final control value may include a refrigerant flow rate of the compressor 151 and an air flow rate introduced through the cooling fan 171.

The control unit 200 may derive the final state value that allows the power consumption unit 101 to perform the indoor cooling with the minimum power consumption while matching an indoor discharge temperature according to the final state value with the target temperature of the indoor cooling. The final state value derived in this way is used in a process of tracking control optimization S420.

More specifically, the control unit 200 may perform tracking control optimization S420 based on a cost function that reflects a tracking cost having a weight for the target temperature tracking performance of the indoor cooling and a control change cost having a weight for a change in control value with respect to the preset prediction range. In this case, the cost function reflecting the tracking cost may be expressed as the following expression.

$$J ( u ) = min {\sum }_{i = 0}^{N - 1} ( {‖ {y}_{t} ( k + i + 1 ) - {y}_{t , target} ‖}_{Q}^{2} + {‖ Δ u ( k + i ) ‖}_{R}^{2} )$$

In the expression,

$${‖ {y}_{t} ( k + i + 1 ) - {y}_{t , target} ‖}_{Q}^{2}$$

corresponds to a tracking cost. Q denotes a weight for tracking performance. The greater the weight Q, the faster the indoor discharge temperature according to the indoor cooling may converge to the target temperature. In addition,

$${‖ Δ u ( k + i ) ‖}_{R}^{2}$$

corresponds to a control change cost. R denotes a weight for a change in control value. The greater the control value R, the slower the indoor discharge temperature according to the indoor cooling converges to the target temperature.

In this case, the control unit 200 may derive, as the optimal control value, a control value that further satisfies the constraint conditions on the target temperature and the constraint conditions on the control change while minimizing the power consumption of the power consumption unit 101.

The constraint conditions on the target temperature may be satisfied when the output value acquired by inputting the predicted state value into the preset first output model for the result of indoor cooling matches the target temperature. In addition, it may be determined whether the constraint conditions are satisfied based on the preset reference range with respect to the change in control value. Also, the constraint conditions may be satisfied when the change in control value is included in the preset reference range.

Furthermore, whether the constraint conditions on the target temperature are satisfied may be determined through the final state value. In this case, the control unit 200 may derive, as the optimal control value, a control value that further satisfies the constraint conditions on the final state value while minimizing the power consumption of the power consumption unit 101. The constraint conditions on the final state value may be satisfied when the state value at the final time point in the prediction range matches the optimal state value derived in steady-state optimization S410.

Since the final state value is derived in consideration of both the tracking of the target temperature and the power consumption in steady-state optimization S410, the control unit 200 may obtain the optimal control value that satisfies the constraint conditions on the target temperature of the indoor cooling while reflecting the final state value to minimize the power consumption of the power consumption unit 101.

Then, the control unit 200 converts the optimal control values derived as physical quantities such as a refrigerant flow rate of the compressor 151 and the air flow rate introduced through the cooling fan 171 into operating quantities such as a driving speed of the compressor 151 and a driving speed of the cooling fan 171 (S430). The fluid transport device 100 operates based on the converted operating quantities (S440).

The control unit 200 determines the state value based on the indoor discharge temperature according to the operation of the fluid transport device 100 (S450). The determined state value is reused for tracking control optimization S420.

Next, referring to FIG. 5, the control unit 200 may perform steady-state optimization S510 before controlling the fluid transport device 100 based on the optimal control value. In this case, steady-state optimization S510 may be performed based on a target temperature range of component thermal management. In this case, disturbance such as a vehicle speed, an outside temperature, a coolant flow rate, and an air flow rate may be considered together.

Steady-state optimization S510 may be performed based on a preset second output model for the result of component thermal management and the power consumption of the power consumption unit 101. In this case, the control unit 200 may perform steady-state optimization S510 using the following expression.

$${Y}_{e , min} \leq {g}_{e} ( {x}_{s} ) \leq {Y}_{e , max}$$

In the expression, gₑ(xₛ) corresponding to the second output model denotes a temperature of a vehicle component as the result of component thermal management according to a final state value xₛ. Also, y_{e,min} and y_{e,mzs} denote a target temperature range of the component thermal management.

In addition, the power consumption of the power consumption unit 101 may be considered in the form of a power model for the power consumption according to the state value and the control value as follows.

$$min {l}_{e} ( {x}_{s} , {u}_{x} ) = min {P}_{cons}$$

In the expression, lₑ(xₛ,uₛ) denotes, as a power model, power consumption P_{cons} according to the final state value xₛ and a final control value uₛ according to a final time point of a prediction range. Therefore, the control unit 200 may derive the final state value xₛ and the final control value uₛ that minimize the power consumption P_{cons} output through the power model.

More specifically, the power consumption unit 101 may include the compressor 151, the cooling fan 171, the coolant pumps 121 and 122 for circulating coolant, and the heater 162 for heating the vehicle component, which are involved in the component thermal management. In this case, the power consumption of the compressor 151, the cooling fan 171, the coolant pumps 121 and 122, and the heater 162 may be included in the power model. Further, the final state value may include the refrigerant temperature of the condenser 152, the refrigerant temperature of the evaporator 156, the refrigerant temperature of the heat absorber 159, the coolant temperature, the vehicle component temperature, and the like. In addition, the final control value may include the refrigerant flow rate of the compressor 151, the air flow rate introduced through the cooling fan 171, the coolant flow rate, and the heat generation quantity of the heater 162.

The control unit 200 may derive the final state value that allows the power consumption unit 101 to perform the component thermal management with the minimum power consumption while component temperatures according to the final state value are included in the target temperature. The final state value derived in this way is used in a process of tracking control optimization S520.

More specifically, the control unit 200 may perform tracking control optimization S520 based on a cost function that reflects the management cost for the target temperature range management performance of the component thermal management with respect to the preset prediction range. In this case, the cost function reflecting the management cost may be expressed as the following expression.

$$J ( u ) = min {\sum }_{i = 0}^{N - 1} ( le ( x ( k + i ) , u ( k + i ) )$$

$${l}_{e} ( x ( k + i ) , u ( k + i ) ) = {P}_{cons}$$

In the expression, lₑ(x(k+i),u(k+i)), corresponding to the management cost, is expressed as the relationship between the predicted state value x(k+i) and the control value u(k+i) accordingly, and denotes power consumption according to the predicted state value x(k+i) and the control value u(k+i).

In this case, the control unit 200 may derive, as the optimal control value, a control value that further satisfies the constraint conditions on the target temperature range and the constraint conditions on the control change while minimizing the power consumption of the power consumption unit 101.

The constraint conditions on the target temperature range may be satisfied when the output value acquired by inputting the predicted state value into the preset second output model for the result of component thermal management is included within the target temperature range. In addition, it may be determined whether the constraint conditions are satisfied based on the preset reference range with respect to the change in control value. Further, the constraint conditions may be satisfied when the change in control value is included in the preset reference range.

Furthermore, whether the constraint conditions on the target temperature range are satisfied may be determined through the final state value. In this case, the control unit 200 may derive, as the optimal control value, a control value that further satisfies the constraint conditions on the final state value while minimizing the power consumption of the power consumption unit 101. The constraint conditions on the final state value may be satisfied when the state value at the final time point in the prediction range matches the optimal state value derived in steady-state optimization S510.

Since the final state value is derived in consideration of both the management of the target temperature range and the power consumption in steady-state optimization S510, the control unit 200 may obtain the optimal control value that satisfies the constraint conditions on the target temperature range of the component thermal management while reflecting the final state value to minimize the power consumption of the power consumption unit 101.

Then, the control unit 200 converts the optimal control values derived as physical quantities such as a refrigerant flow rate of the compressor 151 and the air flow rate introduced through the cooling fan 171 into operating quantities such as a driving speed of the compressor 151 and a driving speed of the cooling fan 171 (S530). The fluid transport device 100 operates based on the converted operating quantities (S540).

The control unit 200 determines the state value based on the component temperature according to the operation of the fluid transport device 100 (S550). The determined state value is reused for management control optimization S520.

Referring to FIG. 6, the control unit 200 may perform steady-state optimization S610 before controlling the fluid transport device 100 based on the optimal control value. In this case, steady-state optimization S610 may be performed based on the target temperature of the indoor cooling and the target temperature range of the component thermal management. In this case, disturbance such as a vehicle speed, an outside temperature, a coolant flow rate, and an air flow rate may be considered together.

Steady-state optimization S610 may be performed based on the present first output model for the result of indoor cooling, the preset second output model for the result of component thermal management, and the power consumption of the power consumption unit 101. In this case, the control unit 200 may perform steady-state optimization S610 using the following expression.

$${g}_{t} ( {x}_{s} ) = {y}_{t , target}$$

$${y}_{e , min} \leq {g}_{e} ( {x}_{s} ) \leq {Y}_{e , max}$$

In the expression, gₜ(xₛ) corresponding to the first output model denotes an indoor discharge temperature discharged from the fluid transport device 100 to the inside as the result of indoor cooling according to a final state value xₛ. Further, y_{t,target} denotes a target temperature of the indoor cooling. gₑ(xₛ) corresponding to the second output model denotes a temperature of a vehicle component as the result of component thermal management according to a final state value xₛ. Further, y_{e,min} and y_{e,mzs} denote a target temperature range of the component thermal management.

In addition, the power consumption of the power consumption unit 101 may be considered in the form of a power model for the power consumption according to the state value and the control value as follows.

$$min {l}_{e} ( {x}_{s} , {u}_{x} ) = min {P}_{cons}$$

In the expression, lₑ(xₛ,uₛ) denotes, as a power model, power consumption P_{cons} according to the final state value xₛ and a final control value uₛ according to a final time point of a prediction range. Therefore, the control unit 200 may derive the final state value xₛ and the final control value uₛ that minimize the power consumption P_{cons} output through the power model.

More specifically, the power consumption unit 101 may include the compressor 151, the cooling fan 171, the coolant pumps 121 and 122 for circulating coolant, and the heater 162 for heating the vehicle component, which are involved in the indoor cooling and the component thermal management. In this case, the power consumption of the compressor 151, the cooling fan 171, the coolant pumps 121 and 122, and the heater 162 may be included in the power model. Also, the final state value may include the refrigerant temperature of the condenser 152, the refrigerant temperature of the evaporator 156, the refrigerant temperature of the heat absorber 159, the coolant temperature, the vehicle component temperature, and the like. In addition, the final control value may include the refrigerant flow rate of the compressor 151, the air flow rate introduced through the cooling fan 171, the coolant flow rate, and the heat generation quantity of the heater 162.

The control unit 200 may derive a final state value that allows the power consumption unit 101 to perform the indoor cooling and the component thermal management with minimum power consumption while the indoor discharge temperature according to the final state value matches the target temperature and the component temperature according to the final state value is included within the target temperature through the above-described first output model, second output model, and power model. The final state value derived in this way is used in a process of comprehensive control optimization S620.

More specifically, the control unit 200 may perform tracking control optimization S620 based on a cost function that reflects a tracking cost having a weight for the target temperature tracking performance of the indoor cooling, a control change cost having a weight for a change in control value, and a management cost for the target temperature range management performance of the component thermal management with respect to the preset prediction range. In this case, the cost function may be expressed as the following expression.

$$J ( u ) = min {\sum }_{i = 0}^{N - 1} ( {l}_{e} ( x ( k + i ) , u ( k + i ) ) + {‖ {y}_{t} ( k + i + 1 ) - {y}_{t , target} ‖}_{Q}^{2} + {‖ Δ u ( k + i ) ‖}_{R}^{2} )$$

In the expression,

$${‖ {y}_{t} ( k + i + 1 ) - {y}_{t , target} ‖}_{Q}^{2}$$

corresponds to a tracking cost. Q denotes a weight for tracking performance. The greater the weight Q, the faster the indoor discharge temperature according to the indoor cooling may converge to the target temperature. In addition,

$${‖ Δ u ( k + i ) ‖}_{R}^{2}$$

corresponds to a control change cost. R denotes a weight for a change in control value. and the greater the control value R, the slower the indoor discharge temperature according to the indoor cooling converges to the target temperature. Further, lₑ(x(k+i),u(k+i)) corresponding to the management cost, is expressed as the relationship between the predicted state value x(k+i) and the control value u(k+i) accordingly, and denotes power consumption according to the predicted state value x(k+i) and the control value u(k+i).

In this case, the control unit 200 may derive, as the optimal control value, a control value that further satisfies the constraint conditions on the target temperature, the constraint conditions on the target temperature range, and the constraint conditions on the control change while minimizing the power consumption of the power consumption unit 101.

The constraint conditions on the target temperature may be satisfied when the output value acquired by inputting the predicted state value to the preset first output model for the result of indoor cooling matches the target temperature. The constraint conditions on the target temperature range may be satisfied when the output value acquired by inputting the predicted state value into the preset second output model for the result of component thermal management is included within the target temperature range. In addition, it may be determined whether the constraint conditions are satisfied based on the preset reference range with respect to the change in control value, and the constraint conditions may be satisfied when the change in control value is included in the preset reference range.

Furthermore, whether the constraint conditions on the target temperature and the constraint conditions on the target temperature range are satisfied may be determined through the final state value. In this case, the control unit 200 may derive, as the optimal control value, a control value that further satisfies the constraint conditions on the final state value while minimizing the power consumption of the power consumption unit 101. The constraint conditions on the final state value may be satisfied when the state value at the final time point in the prediction range matches the optimal state value derived in steady-state optimization S510.

Since the final state value is derived in consideration of all of the tracking of the target temperature, the management of the target temperature range, and the power consumption in steady-state optimization S610, the control unit 200 may obtain the optimal control value that satisfies the constraint conditions on the target temperature of the indoor cooling and the constraint conditions on the target temperature range of the component thermal management while reflecting the final state value to minimize the power consumption of the power consumption unit 101.

Then, the control unit 200 converts the optimal control values derived as physical quantities such as a refrigerant flow rate of the compressor 151 and the air flow rate introduced through the cooling fan 171 into operating quantities such as a driving speed of the compressor 151 and a driving speed of the cooling fan 171 (S630). The fluid transport device 100 operates based on the converted operating quantities (S640).

The control unit 200 determines the state value based on the component temperature according to the operation of the fluid transport device 100 (S650) The determined state value is reused for management control optimization S620.

In one embodiment, steady-state optimization S410, S510, and S610 described with reference to FIGS. 4-6 may be omitted.

In this case, tracking control optimization S420, management control optimization S520, and comprehensive control optimization S620 may be performed without considering the final state value.

According to various embodiments of the present disclosure, it is possible to satisfy the thermal management goals for thermal management targets while consuming the minimum power by comprehensively considering the interaction between the thermal management targets.

In particular, the thermal management system according to various embodiments of the present disclosure can be applied to both a case in which control of tracking a target value is required and a case in which control for management within a target range is required in satisfying the thermal management goals and can simultaneously perform tracking control and management control as needed.

Although the specific embodiments of the present disclosure have been illustrated and described above, it should be apparent to those having ordinary skill in the art that the present disclosure may be variously improved and changed without departing from the technical spirit of the present disclosure provided by the appended claims.

What is claimed is:

1. A vehicle thermal management system comprising:
a fluid transport device configured to selectively perform indoor cooling through air discharge into a vehicle interior and component thermal management through heat exchange with at least one vehicle component, wherein the fluid transport device includes a power consumption unit configured to consume power to perform the indoor cooling and the component thermal management; and
a control unit configured to control the fluid transport device based on an optimal control value derived using a preset control model for a predicted state value according to a current state value,
wherein the optimal control value is a control value that satisfies constraint conditions on at least one of a target temperature of the indoor cooling or a target temperature range of the component thermal management while consuming minimum power through the power consumption unit.

2. The vehicle thermal management system of claim 1, wherein the control unit is further configured to derive the optimal control value based on a cost function that reflects at least one of a tracking cost having a weight for target temperature tracking performance of the indoor cooling or a management cost for target temperature range management performance of the component thermal management with respect to a preset prediction range.

3. The vehicle thermal management system of claim 2, wherein, when performing the indoor cooling, the control unit is further configured to derive the optimal control value based on the cost function that reflects the tracking cost.

4. The vehicle thermal management system of claim 3, wherein:
the control unit is further configured to derive, as the optimal control value, the control value that satisfies the constraint conditions on the target temperature of the indoor cooling while consuming the minimum power through the power consumption unit; and
the constraint conditions on the target temperature are satisfied when an output value obtained by inputting the predicted state value into a preset first output model for a result of the indoor cooling matches the target temperature.

5. The vehicle thermal management system of claim 3, wherein, when performing the indoor cooling, the control unit is further configured to derive the optimal control value based on the cost function that further reflects a control change cost having a weight for a change in the control value.

6. The vehicle thermal management system of claim 3, wherein the current state value and the predicted state value include a temperature of refrigerant that circulates in the fluid transport device and exchanges heat with surrounding air.

7. The vehicle thermal management system of claim 6, wherein the power consumption unit includes a compressor configured to compress and discharge the refrigerant, and wherein the optimal control value includes a flow rate of the refrigerant discharged from the compressor.

8. The vehicle thermal management system of claim 6, wherein the power consumption unit includes a fan configured to introduce outside air of the vehicle into the fluid transport device, and wherein the optimal control value includes a flow rate of the outside air flowing into the fluid transport device.

9. The vehicle thermal management system of claim 2, wherein, when performing the component thermal management, the control unit is further configured to derive the optimal control value based on the cost function that reflects the management cost.

10. The vehicle thermal management system of claim 9, wherein:
the control unit derives, as the optimal control value, the control value that satisfies the constraint conditions on the target temperature range while consuming the minimum power through the power consumption unit; and
the constraint conditions on the target temperature range are satisfied when an output value obtained by inputting the predicted state value into a preset second output model for a result of the component thermal management is included within the target temperature range.

11. The vehicle thermal management system of claim 9, wherein the current state value and the predicted state value include at least one of a temperature of the vehicle component, a temperature of coolant that circulates in the fluid transport device and exchanges heat with the vehicle component, or a temperature of refrigerant that circulates in the fluid transport device and exchanges heat with the coolant.

12. The vehicle thermal management system of claim 11, wherein the power consumption unit includes a compressor configured to compress and discharge the refrigerant, and wherein the optimal control value includes a flow rate of the refrigerant discharged from the compressor.

13. The vehicle thermal management system of claim 11, wherein the power consumption unit includes a coolant pump configured to circulate the coolant, and wherein the optimal control value includes a flow rate of the circulating coolant.

14. The vehicle thermal management system of claim 11, wherein the power consumption unit includes a fan configured to introduce outside air of the vehicle into the fluid transport device, and wherein the optimal control value includes a flow rate of the outside air flowing into the fluid transport device.

15. The vehicle thermal management system of claim 11, wherein the power consumption unit includes a heater configured to heat the vehicle component, and wherein the optimal control value includes power consumption of the heater.

16. The vehicle thermal management system of claim 2, wherein the control unit is further configured to determine whether the constraint conditions on at least one of the target temperature of the indoor cooling and the target temperature range of the component thermal management is satisfied through a final state value corresponding to a final time point of the preset prediction range.

17. The vehicle thermal management system of claim 16, wherein the final state value is determined based on at least one of a preset first output model for a result of the indoor cooling and a preset second output model for a result of the component thermal management, or a power model for power consumption of the power consumption unit.

18. The vehicle thermal management system of claim 17, wherein, when the indoor cooling is performed, the final state value is a state value that allows an output value of the preset first output model corresponding to the final time point of the prediction range to match the target temperature.

19. The vehicle thermal management system of claim 17, wherein, when the component thermal management is performed, the final state value is a state value that allows an output value of the preset second output model corresponding to the final time point of the prediction range to match the target temperature range.

20. The vehicle thermal management system of claim 1, wherein the control unit is further configured to derive, as an optimal control value, a control value that further satisfies constraint conditions on a control change, and wherein satisfaction of the constraint conditions on the control change is determined based on a preset reference range with respect to a change in control value.
